(19) United States
(12) Patent Application Publication
(10) Pub. No.: US 2003/0217187 A1
(43) Pub. Date: Nov. 20, 2003

(54) System and method for locating a network adapter

(75) Inventor: David Paul Kuiken, Round Rock, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/150,003

(22) Filed: May 16, 2002

(51) Int. Cl. G06F 15/16

(52) U.S. Cl. 709/250; 709/230

(57) ABSTRACT

A network adapter according to the present invention is configured to issue an audible signal upon detecting a predetermined network command. The predetermined command may comprise an existing network command, such as a ping-type command. Alternatively, the predetermined command could be implemented as an extension of existing network commands. Typically, various attributes of the feature are configurable including, as examples, the type of sound, frequency, duration, and pattern. The network adapter includes an audio element and a state machine configured to activate the audio element upon receiving an appropriate element. When a network packet addressed to a system having an appropriately configured audio element receives a packet comprising a predetermined network command, the audio element is activated thereby giving an audio indication of the system's physical location.

### BACKGROUND

1. Field of the Present Invention

The present invention generally relates to the field of data processing networks and more particularly to a method and system that facilitates locating a particular network adapter when many adapters are present.

2. History of Related Art

Data processing networks typically include a plurality of interconnected data processing systems such as server machines, desktop and laptop computers, network computers and workstations, and the like. The various devices comprising the network each connect to a network medium such as a twisted wire pair, a coaxial cable, and so forth. In conventional data processing system architecture, each network communication device is a microprocessor-based system that includes one or more peripheral devices that expand the system's I/O capabilities. In a networked environment, these peripheral devices almost universally include some form of network adapter card, also commonly referred to as a network interface card (NIC). The NIC is an I/O adapter that connects a data processing system or other intelligent device to a network.

Perhaps the most familiar network implementation is the Transmission Control Protocol/Internet Protocol (TCP/IP) network. TCP and IP are network protocols defined by the Internet Engineering Task Force (IETF). See the IETF web site (www.ietf.org) for the complete TCP and IP specifications, referred to as RFC's. TCP is defined in RFC 793 and IP is defined in RFC 791. In a TCP/IP compliant network, each NIC that is actively connected to the network is associated with its own IP address. Frequently, IP addresses are assigned dynamically so that, for example, a limited number of IP addresses can be distributed on an as-needed basis to a large number of devices. When a device terminates its network session, its IP address can be assigned to another device. The IETF's Dynamic Host Configuration Protocol (DHCP) specification (RFC 2131) provides a framework for passing configuration information to hosts on a TCP/IP network. DHCP includes the capability of automatic allocation of reusable network addresses and additional configuration options.

While dynamic allocation of IP addresses is beneficial for conserving and optimizing the use of scarce network IP addresses, it can make it difficult to determine which IP address corresponds to a particular NIC. This is especially true in environments where many data processing systems are located in close proximity to each other. Such environments are common in educational settings, research labs, and Internet data centers, among others.

Under certain circumstances, it may be highly desirable to locate the physical system associated with a particular IP address. This can be a time consuming process in a DHCP environment. Accordingly, it would be desirable to implement facilities and a method of using them that would enable the rapid location of a NIC associated with a known IP address. It would be further desirable if the implemented solution complied, to the greatest extent possible, with existing network protocols and if the solution did not significantly increase the cost or complexity of the network.

### SUMMARY OF THE INVENTION

The problems identified above are in large part addressed by a network adapter according to the present invention. The adapter is configured to issue an audible signal upon receiving a predetermined network command. The predetermined command may comprise an existing network command, such as a ping-type command. Alternatively, the predetermined command could be implemented as an extension of existing network commands. Typically, various parameters of the audible signal are configurable including, as examples, the frequency, volume and duration of the signal. The network adapter includes an audio element and a state machine configured to activate the audio element upon receiving an appropriate command. When a network packet addressed to a system having an appropriately configured audio element receives a packet comprising a predetermined network command, the audio element is activated thereby giving an audio indication of the system's physical location.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing system including a network adapter according to one embodiment of the present invention;

FIG. 2 is a block diagram of selected elements of the network adapter of FIG. 1;

FIG. 3 is a block diagram of a data processing network illustrating an application of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

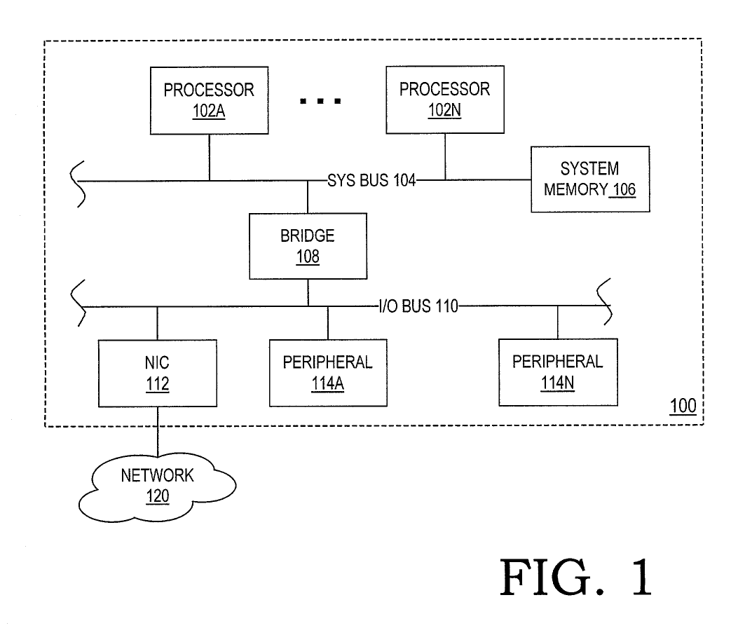

Turning now to the drawings, FIG. 1 is a block diagram of selected features of a data processing system 100 according to one embodiment of the present invention. In the depicted embodiment, data processing system 100 includes a set of main processors 102A through 102N (generically or collectively referred to as processor(s) 102) that are connected to a system bus 104. A common system memory 106 is accessible to each processor 102 via system bus 104. The system memory is typically implemented with a volatile storage medium such as an array of dynamic random access memory (DRAM) devices. The depicted architecture of data processing system 100 is frequently referred to as a symmetric multiprocessor (SMP) system because each processor 102 has substantially equal access to system memory 106.

In data processing system 100, a bus bridge 108 provides an interface between system bus 104 and an I/O bus 110 to which one or more peripheral devices 114A through 114N (generically or collectively referred to as peripheral device(s) 114) are connected. I/O bus 110 is typically compliant with one of several industry standard I/O bus specifications including, as a common example, the Peripheral Components Interface (PCI) bus as specified in PCI Local Bus Specification Rev 2.2 by the PCI Special Interest Group (www.pcisig.com).Peripheral devices 114 may include devices such as a graphics adapter, a hard-disk controller, and the like.

Data processing system 100 further includes a network communication device or adapter identified in FIG. 1 as NIC 112. Although referred throughout this disclosure as an adapter, interface card, or NIC, it will be appreciated that the network communication device may be implemented as a chip set located on a processor board or in some other fashion not generally consistent with the notion of an adapter as a stand-alone printed circuit board that is plugged into an adapter slot of a data processing system.

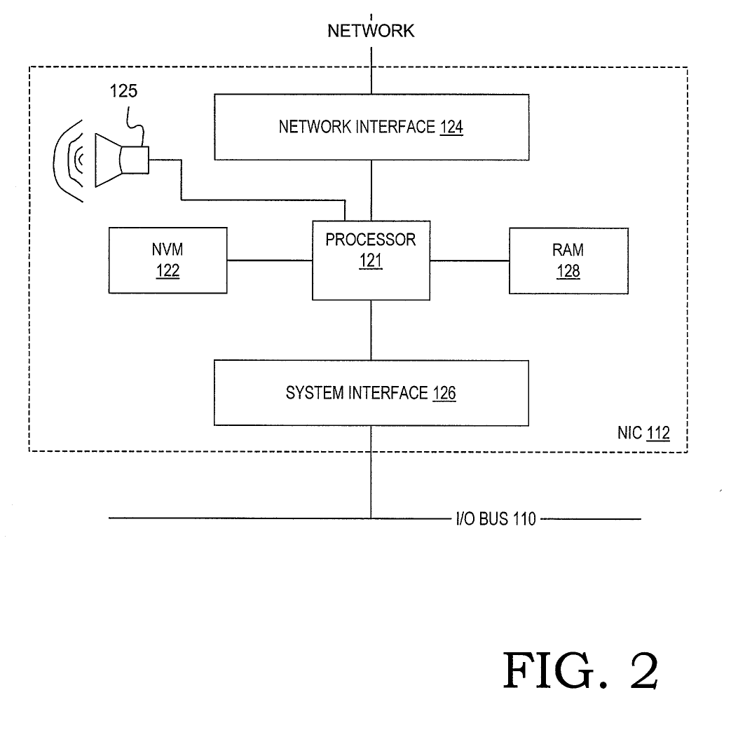

Network adapter 112 generally provides an interface, including appropriate control logic and buffering, between I/O bus 110 and a network identified by reference numeral 120. Referring now to FIG. 2, additional details of selected elements of NIC 112 according to the present invention are depicted. In the depicted embodiment, NIC 112 includes a network interface 124 that connects NIC 112 with the physical network. Network interface 124 typically includes appropriate magnetic elements or other electronics required of or by the network medium and protocol. In addition, network interface 124 typically includes appropriate buffering and logic to control the exchange of information between NIC 112 and network 120.

NIC 112 as depicted in FIG. 2 further includes a local or embedded processing device or state machine identified by reference numeral 121 connected to network interface 124. Processor 121, in conjunction with software stored in a nonvolatile storage device identified as NVM 122, performs the network protocol processing on data received from or transmitted to network 120. In a TCP/IP implementation, for example, NVM 122 will typically contain the protocol stack firmware. NVM 122 may comprise a conventional ROM or EEPROM device, a flash memory card, or any other appropriate form of nonvolatile storage. In addition to NVM 122, processor 121 of NIC 112 typically has access to some amount of random access storage identified in FIG. 2 as RAM 128. RAM 128 provides “scratch” memory for any processing required of processor 121. RAM 128 is typically implemented with a static RAM device to achieve desirable performance although other forms of memory such as dynamic RAM are possible. NIC 112 as depicted in FIG. 2 further includes a system interface unit 126 that provides appropriate buffering and control between NIC 112 and I/O bus 110 of the host system.

NIC 112 is generally configured in accordance with the present invention to produce an audible signal upon receiving an appropriately addressed and formatted packet via network 120. To accomplish this objective, NIC 112 includes an audio element 125 connected to processor 121. Audio element 125 is typically comprised of a micro speaker having a diameter of less than 50 mm and more preferably of less than 25 mm. Audio element 125, as its name implies, is capable of producing an audible signal upon appropriate activation by processor 121. In the context of the present invention, NIC 112 is configured to activate audio element 125 in response to receiving one or more predetermined network commands. In this manner, NIC 112 is designed for being readily detected by anyone within hearing range of audio element 125. In the preferred embodiment, audio element 125 is configurable via software commands or storage registers on processor 121. The configurable features of audio element 125 typically include the type of sound produced, the frequency, duration, and the pattern. In addition, NIC 112 may include the ability to disable audio element 125.

Portions of the present invention may be implemented as a sequence of computer or processor executable instructions (i.e., software or computer code). In such cases, the software is stored on some form of computer readable medium. In the context of the present invention as depicted in FIG. 2, portions of any software elements pertaining to the invention may be stored in NVM 122 or RAM 128. Assuming that the access time associated with RAM 128 is faster than the access time of NVM 122, for example, NIC 112 may be configured to copy portions of code from NVM 122 to RAM 128 during the time that NIC 112 is powered on. Processor 121 would then be able to execute code stored in RAM 128.

According to the present invention, NIC 112 is configured to respond to receipt of predetermined network commands by producing an audible signal thereby facilitating the task of locating of NIC 112 (and its corresponding system) by a network administrator, technician, or other user. To accomplish this goal, NVM 122 typically includes software code that responds to the receipt of selected network commands by having processor 121 activate audio element 125. In one embodiment, the network command(s) that result in the activation of audio element 125 are dedicated for that purpose. In other words, the audio activation commands may comprise previously non-existent commands that are designed specifically for the sole purpose of activating audio element 125. For purposes of illustration, NIC 112 may be configured to recognize a “NET BEEP” or “NET IDENTIFY” command and to activate the audio element in response thereto. In other embodiments, the software code may be configured to activate audio element 125 in response to a ping-type command. In a typical ping command sequence, a NIC receives an ECHO request and issues a corresponding ECHO reply. The ECHO request and reply are defined under the Internet Control Message Protocol (ICMP), RFC 792. Thus, NIC 112, via code stored in NVM 122, may be configured to respond to a ping request by activating audio element 125 in addition to issuing an ECHO response. While this embodiment beneficially eliminates the need to modify the system issuing the request, it may result in undesirably frequent or inappropriate activation of audio element 125. The ping command may be used for many purposes unrelated to the need to locate a particular system physically. In such cases, activating audio element 125 upon each ping command is undesirable. To accommodate this reality, one embodiment of NIC 112 may permit the deactivation of audio element 125 that effectively mutes audio element 125. In this manner, audio element 125 could be activated only when needed for location purposes and muted thereafter.

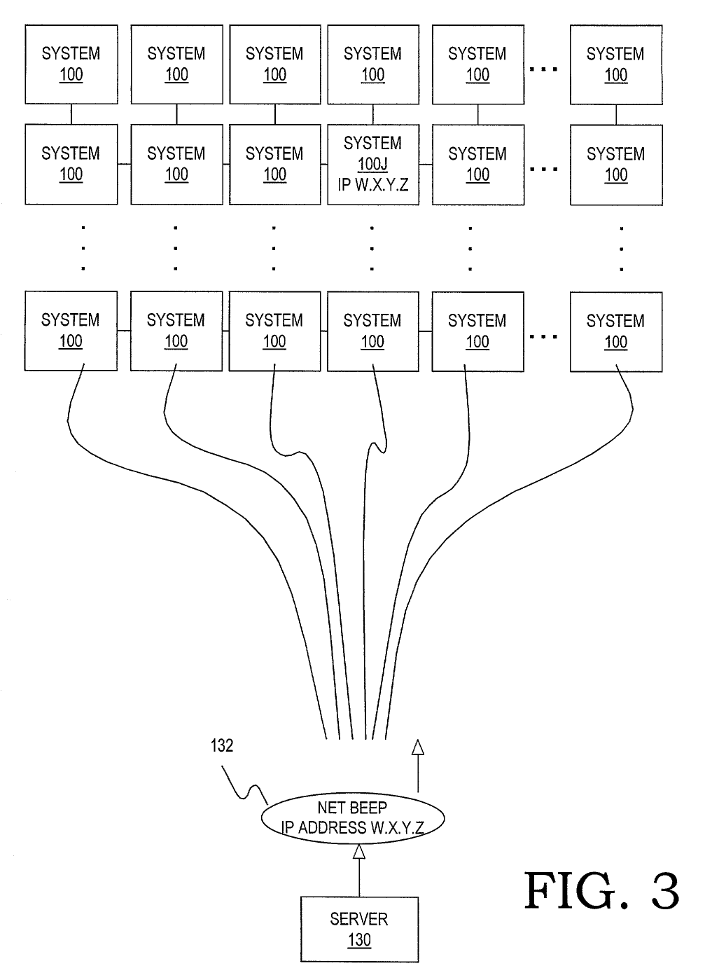

The present invention is particularly suitable for locating a data processing system or device on a network comprising many systems. Each data processing system is associated with at least one network address. In a TCP/IP network, each data processing system has at least one IP address. To locate a particular system, a user would issue a predetermined, audio-activating network command to the system's IP address. Referring to FIG. 3, an illustration of the audio location of a data processing system in a network of such systems is presented. As depicted in FIG. 3, a plurality of systems 100 are each connected to a network 120. Network 120 may comprise a local area network (LAN) such as an Ethernet or token ring network or a combination of multiple LAN's. In many applications, the plurality of systems 100 densely populate a limited amount of space such that many systems may be found in a single room as is common in many data center, raised floor, and other applications.

In the field of network administration, a problem system may be first identified by its IP address. Imagine, for example, a situation in which a computer virus infects some of the systems 100 in a network. A network service group could perform a scan procedure to detect occurrences of the virus and issue a report identifying the infected IP addresses. In many cases, it would then be necessary to locate the corresponding systems so that corrective action could be taken. With dynamically assigned IP addresses, it might be time consuming to locate each system “manually.”

The network according to the present invention is configured to issue an audio activation command as part of a network packet. The packet includes an IP address of the system to be located. FIG. 3, illustrates a server 130 issuing a NET BEEP command as part of a network packet 132 containing the hypothetical IP address W.X.Y.Z. This packet is sent out to a network comprising a set of data processing system 100 including the data processing system 100J currently assigned the IP address W.X.Y.Z. When system 100J detects and receives packet 132, its audio element 125 (not depicted in FIG. 3) will be activated thereby giving the system administrator an audio indicator of its location.

It will be apparent to those skilled in the art having the benefit of this disclosure that the present invention contemplates a system and network that facilitate the ability to detect a system's physical location via the network. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A network communication device, comprising:
a network interface unit suitable for controlling the exchange of information between the network communication device and a network;
a processor connected to the network interface and configured to perform protocol processing on information transmitted to or received from the network;
an audio element connected to the processor and suitable for generating an audible signal; and
computer code means for enabling the processor to activate the audio element responsive to receiving a network packet addressed to the device and containing a command selected from a set of predetermined commands.

2. The network communication device of claim 1, wherein the network implements a TCP/IP protocol and further wherein the processor is configured to activate the audio element responsive to receiving a network packet with an IP address that matches the IP addressed currently assigned to the communication device.

3. The network communication device of claim 1, further comprising a printed circuit board to which the processor and audio element are connected, wherein the printed circuit board is suitable for insertion in an adapter slot of a data processing system.

4. The network communication device of claim 1, wherein the audio element includes a micro speaker having a diameter of less than 50 mm.

5. The network communication device of claim 1, wherein the set of predetermined commands includes a PING command that includes an ECHO request and to which a corresponding ECHO reply is returned.

6. The network communication device of claim 1, wherein selected parameters of the audio element are configurable by the processor.

7. The network communication device of claim 6, wherein the configurable parameters include, the frequency, duration, and volume of the audible signal.

8. The network communication device of claim 6, wherein the configurable parameters include a deactivation parameter that mutes the audio element.

9. A data processing system, including a central processor and system memory and further including a network interface device, comprising:
a network interface unit suitable for controlling the exchange of information between the network communication device and a network;
a processor connected to the network interface and configured to perform protocol processing on information transmitted to or received from the network;
an audio element connected to the processor and suitable for generating an audible signal; and
computer code means for enabling the processor to activate the audio element responsive to receiving a network packet addressed to the device and containing a command selected from a set of predetermined commands.

10. The data processing system of claim 9, wherein the network implements a TCP/IP protocol and further wherein the processor is configured to activate the audio element responsive to receiving a network packet with an IP address that matches the IP addressed currently assigned to the communication device.

11. The data processing system of claim 9, further comprising a printed circuit board to which the processor and audio element are connected, wherein the printed circuit board is suitable for insertion in an adapter slot of a data processing system.

12. The data processing system of claim 9, wherein the audio element includes a micro speaker having a diameter of less than 50 mm.

13. The data processing system of claim 9, wherein the set of predetermined commands includes a PING command that includes an ECHO request and to which a corresponding ECHO reply is returned.

14. The data processing system of claim 9, wherein selected parameters of the audio element are configurable by the processor.

15. The data processing system of claim 14, wherein the configurable parameters include, the frequency, duration, and volume of the audible signal.

16. The data processing system of claim 14, wherein the configurable parameters include a deactivation parameter that mutes the audio element.

17. A data processing network, comprising:
a network server; and
a set of interconnected data processing systems connected to the server, wherein at least one of the data processing systems includes:
a central processor and system memory and further including a network interface device, comprising:
a network interface unit suitable for controlling the exchange of information between the network communication device and a network;
a processor connected to the network interface and configured to perform protocol processing on information transmitted to or received from the network;
an audio element connected to the processor and suitable for generating an audible signal; and
computer code means for enabling the processor to activate the audio element responsive to receiving a network packet addressed to the device and containing a command selected from a set of predetermined commands.

18. The network of claim 17, wherein the network implements a TCP/IP protocol and further wherein the processor is configured to activate the audio element responsive to receiving a network packet with an IP address that matches the IP addressed currently assigned to the communication device.

19. The network of claim 17, further comprising a printed circuit board to which the processor and audio element are connected, wherein the printed circuit board is suitable for insertion in an adapter slot of a data processing system.

20. The network of claim 17, wherein the audio element includes a micro speaker having a diameter of less than 50 mm.

21. The network of claim 17, wherein the set of predetermined commands includes a PING command that includes an ECHO request and to which a corresponding ECHO reply is returned.

22. The network of claim 17, wherein selected parameters of the audio element are configurable by the processor.

23. The network of claim 22, wherein the configurable parameters include, the frequency, duration, and volume of the audible signal.

24. The network of claim 22, wherein the configurable parameters include a deactivation parameter that mutes the audio element.
